(19) United States
(12) Patent Application Publication
(10) Pub. No.: US 2006/0144718 A1
(43) Pub. Date: Jul. 6, 2006

(54) Method and apparatus for removing and controlling microbial contamination in dental unit water lines by electrolysis

(76) Inventor: John M. Lambie, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 10/815,174

(22) Filed: Mar. 26, 2004

Related U.S. Application Data
(60) Provisional application No. 60/458,313, filed on Mar. 28, 2003.

(51) Int. Cl. C02F 1/461

(52) U.S. Cl. 205/701

(57) ABSTRACT

Apparatus for removing and controlling microbial contamination in dental unit water includes a source of water and an electrolytic subsystem located between the source and a dental unit that continuously treats all the water from the source before the water enters the dental unit. The subsystem does not segregate the anolyte from the catholyte, does not require a separate source of salt or brine, and generates hypochlorite and other active halide compounds from salt naturally present in the water. The subsystem may be formed as an electrolytic cell that can be located in-line between the source of water and the dental unit.

### CROSS-REFERENCE TO RELATED APPLICATIONS

This application claims priority to U.S. Provisional Patent Application Ser. No. 60/458,313, filed Mar. 28, 2003 and entitled “Method and Apparatus for Removing and Controlling Microbial Contamination in Dental Unit Water Lines by Electrolysis”.

The invention includes a method and apparatus for removing and controlling microbial contamination in dental unit water lines by electrolysis. The invention is believed to be useful to detect and eradicate microbial biofilms in dental equipment.

According to the National Institute of Dental and Craniofacial Research, there is a need for:
low-cost effective devices and methodologies for the prevention and control of biofilms in dental unit water lines,
low-cost effective devices and methodologies for consistent delivery of water with microbial levels below 200 CFU's/mil, and
new chemical germicides that can be used in settings where there is no potable water, inconsistent electrical power, and/or limited sterilization equipment.

The invention includes an electrolytic cell and control system that can be formed as a stand-alone product or as a subsystem of a dental operatory for disinfecting dental unit water lines. The electrolytic system of the invention will offer the following advantages:
The electrolyzed water will be bactericidal.
The electrolyzed water will not be toxic or irritating to humans.
The electrolyzed water will detach biofilms from dental unit water lines and prevent them from recurring.
The electrolyzed water will not damage the internal components of the operatory.
The electrolytic system will be inexpensive, robust, reliable, and easy to use. The electrolytic system will not require attention from the dental staff except during monthly maintenance.
The electrolytic system will operate in continuous mode; it will not require labor or system shutdown for batch cleaning.
The electrolytic system will operate successfully in remote field conditions and other non-traditional settings.
The water reaching the patient will meet the American Dental Association's goal of 200 or fewer colony forming units per milliliter.

No conventional product provides the above advantages.

### BACKGROUND OF THE PROBLEM

Dr. C. G. Blake first reported the existence of contaminated water in dental units in Great Britain in 1963.¹ The U.S. dental community became more interested in water-related infection control issues after the emergence of the worldwide HIV epidemic. Reports of waterline contamination by Legionella and other potential pathogens surfaced in 1990.² The Centers for Disease Control began to recommend specific infection control practices for dentistry in 1993.³
¹ Blake C G, The incidence and control of infection in dental spray reservoirs, Br Dent J 1963; 115:412-6.

² Pankhurst C L, Philpott-Howard J N, Hewitt J H, Casewell M W, The efficacy of chlorination and filtration in the control and eradication of Legionella from dental chair water systems, J Hosp Infect 1990; 16-9-18.

³ Centers for Disease Control and Prevention, Recommended infection control practices for dentistry, 1993. MMWR 1993; 42(No. RR-8): 1-12.

In 1994, researchers documented levels of microbial contamination as high as 1,000,000 colony forming units per milliliter (CFU/ml).⁴ New dental unit water lines can accumulate up to 200,000 colony forming units of microbial contamination per milliliter (CFU/ml) after only 5 days of operation.⁵ The Safe Drinking Water Act mandates a maximum heterotrophic plate count of 500 CFU/ml.⁶
⁴ Santiago J I, Huntington M K, Johnston A M, Quinn R S, Williams J F, Microbial contamination of dental unit water lines: short- and long-term effects of flushing, Gen Dent 1994; 42:528-35.

⁵ Barbeau J, Tanguay R, Faucher E, Multiparametric analysis of waterline contamination in dental units, Appl Environ Microbiol 1996; 62:3954-9.

⁶ US Environmental Protection Agency, National Primary Drinking Water Regulations, 1999, available at http://www.epa.gov/safewater/mcl. html#3, accessed Mar. 20, 2003.

The high levels of bacterial contamination in dental unit water lines do not yet threaten the health of the general population, but they may constitute a hazard for the growing population of immuno-compromised patients.⁷ The scientific literature contains at least two reports of cancer patients with postoperative infections caused by pseudomonas aeruginosa, apparently originating in dental unit water lines.⁸ The potential adverse consequences of contaminated dental water unit lines include not only disease and death to dental patients, but also health risks and economic risks (such as adverse publicity and litigation) to dental professionals.⁹
⁷ Shearer B G, Biofilm and the dental office, JADA 1996; 27: 181-189.

⁸ Martin M V, The significance of bacterial contamination of dental unit water systems, Br Dent J 1987, 163: 152-154.

⁹ Clappison R A, Priority one: decontamination of dental unit water lines, Oral Health 1997, June: 11-15.

In 1995, the American Dental Association Council on Scientific Affairs recommended “an ambitious and aggressive course to encourage industry and the research community to improve the design of dental equipment so that by the year 2000, water delivered to patients during nonsurgical dental procedures consistently contains no more than 200 colony forming units per milliliter of aerobic mesophilic heterotrophic bacteria at any time in the unfiltered output of the dental unit.”¹⁰
¹⁰ Preface to ADA Statement on Dental Unit Waterlines, http:llwww.ada.org/prof/prac/issues/statements/lines.html, accessed Mar. 20, 2003.

Neither the evidence of microbial contamination nor the ADA recommendations have significantly changed the practice of dentistry. In 2000, Mills urged dentists to take responsibility for the purity of their water systems. “Water that is unfit to drink as defined by nationally recognized standards is unsuitable for therapeutic use in dentistry. Continued inaction on the part of the dental profession can serve only to undermine public confidence in our commitment to quality dental care.”¹¹
¹¹ Mills S E, The Dental Unit Waterline Controversy: Defusing the Myths, Defining the Solutions, JADA, vol. 131, October 2000, 1427-1441.

The Centers for Disease Control recently released its Draft Recommended Infection Control Practices for Dentistry, 2003, which recommended a looser standard than the ADA had promulgated in 1996. The CDC document suggested that dental professionals “Use water that meets standards set by the EPA for drinking water (fewer than 500 CFU/ml of heterotrophic water bacteria) for routine dental treatment output water.”

Biofilms as the Source of the Problem

During the first few years after the discovery of ubiquitous microbial contamination in dental unit water lines, researchers assumed the systems were retracting bacteria from patients' mouths. However, many studies have since confirmed that biofilms in the dental tubing are the primary source of the bacteria.¹² Dental units which receive water from municipal water systems can accumulate high levels of contamination quickly because biofilms grow on the internal walls of the dental tubing.
¹² Whitehouse R L S, Peters E, The influence of biofilms on microbial contamination in dental unit water, J Dent 1991; 19:290-295.

A biofilm is a complex community of bacteria that grows on solid surfaces in the presence of moisture. Biofilms typically host multiple species of bacteria covered by a glycocalyx, a polysaccharide slime layer, which protects the bacteria from chemical attack.¹³ The plaque which forms on teeth and causes tooth decay is one example of a biofilm.¹⁴
¹³ Costerton J W, The formation of biocide-resistant biofilms in industrial, natural, and medical systems, Dev Ind Microbiology 1984; 25: 363-372.

¹⁴ Marsh P D, Bradshaw D J, Dental plaque as a biofilm, J Ind Microbiol 1995; 15:169-75.

Within biofilms, bacteria can activate different sets of genes, thereby becoming essentially different organisms. Species of bacteria can form complex symbiotic relationships with other species and communicate with them by chemical signals.

Biofilms grow in thickness until they reach a “steady state” condition in which they release old material and grow new material at approximately the same rate. Dental unit water lines provide ideal breeding grounds for biofilms for three reasons:¹⁵
¹⁵ Mills, ibid.

Minerals in the feed water deposit on the inner walls of the dental tubing and provide an excellent substrate for adhesion of bacteria.
Water moves through the narrow tubing in a laminar flow pattern that minimizes mechanical pressure on the biofilm.
Dental tubing has a high surface-to-volume ratio.
   Commercial Products for Removing Biofilms from Dental Unit Water Lines

Mills prefaced his review of the available treatment technologies with this statement:
“An ideal agent for control of biofilm would be bactericidal but not toxic or irritating to humans. It would detach biofilm and discourage subsequent reformation, while protecting the dental units' internal components from corrosion or degradation. If delivered continuously in treatment water, it would have no effect on enamel or dentin bonding agents. And, of course, to be truly ideal, it would be inexpensive and easy to use. Although such an agent does not appear to exist, there are products that possess some of these desired characteristics.”¹⁶
   ¹⁶ Mills, ibid.

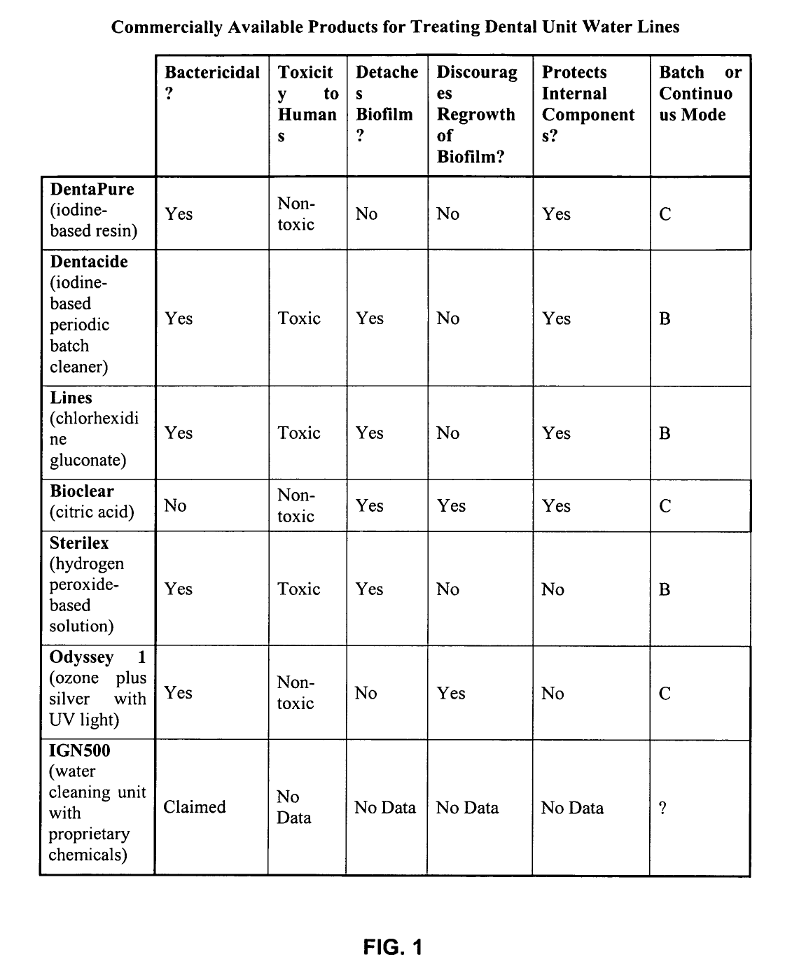

FIG. 1 includes a table that summarizes the characteristics of the available chemical products for cleaning dental unit water lines. These products operate either in batch mode or continuous mode. They all have one or more significant disadvantages (indicated by shaded cells). The products which operate in batch mode require frequent applications to keep the microbial readings below 500 CFU/ml.

Sterilex and Lines require highly trained operators. The products which operate in continuous mode have one of two problems: either they can't prevent biofilm growth, or they tend to damage plastic components in the operatory. DentaPure and Dentacide react with organic matter to produce iodine-based allergens.

The dental community hasn't solved the problem of biofilm growth because industry hasn't yet created a simple, low-cost solution. To assure that water from an operatory meets drinking water standards, a dentist must rely on a combination of continuous and intermittent chemical treatments. For example, Karpay has demonstrated that weekly treatment with 5.25% NaClO (sodium hypochlorite) diluted 1:10, accompanied by the use of chlorinated treatment water (3 ppm chlorine), consistently delivered output water with fewer than 10 CFU/ml of microbial contamination. However, he pointed out these issues:
Treatment success requires conscientious performance of recommended protocols by clinical staff members.
The periodic use of hazardous chemicals in batch mode creates some risk of inadvertent exposure for patients and staff.
The chemicals can corrode or weaken some components in some dental systems.
The effects of continuous treatment on dentin and enamel bond strength may require further evaluation.¹⁷
   ¹⁷ Karpay R I, Plamondon T J, Mills S E, Combining Periodic and Continuous Sodium Hypochlorite Treatment to Control Biofilms in Dental Unit Water Systems, JADA, Vol. 130, July 1999, 957-965.

No commercial products for disinfecting dental unit water lines rely on electrolysis. The invented electrolysis system will provide the ideal solution. The mechanisms by which electrolysis can disinfect water are presented below, followed by evidence that electrolyzed water can remove biofilms.

Water Disinfection by Electrolysis

Electrolysis is a method of breaking water down into molecular hydrogen and molecular oxygen. This reaction occurs at the cathode:
4H₂O+4e⁻→4H⁻+4OH⁻→2H₂+4OH⁻

This reaction occurs at the anode:
4H₂O→4H⁺+4OH⁻−4e⁻→O₂+2H₂O+4H⁺

Since the H⁺ and OH⁻ ions migrate toward each other and recombine, the net reaction is
2H₂O→2H₂+O₂

Electrolysis can disinfect water by at least three mechanisms:
the action of molecular oxygen,
generation of hypochlorite and other active compounds,
rupturing of cell membranes at the anode, and
the action of nascent and molecular hydrogen.
   The Action of Molecular Oxygen

Molecular oxygen, a vigorous electron acceptor, can kill anaerobic micro-organisms in water.^{18,19,20} Furthermore, the interaction of molecular oxygen with water at the cathode can produce hydroperoxide ions by this reaction:
¹⁸ Morris J G, “Nature of oxygen toxicity in anaerobic microorganisms”, in Shilo, M. (ed.) Strategies of microbial life in extreme environments, p. 149-162, Weinheim Verlag Chemie, 1979.

¹⁹ Uesugi I. and Yajima M, Oxygen and strictly anaerobic intestinal bacteria, I. Effects of dissolved oxygen on growth, Zeitschrift für Aligemeine Mikrobiologie, vol. 18, pp. 287-295,1978.

²⁰ Loesche W. J., “Oxygen sensitivity of various anaerobic bacteria.” Applied Microbiology, Vol. 18, pp. 723-727, 1969.

O₂+H₂O+2e⁻→HO₂⁻+OH⁻

Hydroperoxide ions can also destroy bacteria.²¹
²¹ Porta A and Kulhanek A, Process for the electrochemical decontamination of water polluted by pathogenic germs with peroxide formed in situ, U.S. Pat. No. 4,619,745, 1986.

Generation of Hypochlorite and Other Active Halide Compounds

All natural water contains trace quantities of salts in solution. Potable water supplies generally contain chloride salts in concentrations of 10 to 250 ppm. Cl⁻ ions in the water will oxidize at the anode to produce Cl₂, initiating this series of reactions:
2Cl⁻−2e⁻→Cl₂
Cl₂+H₂O→HOCl+HCl
Cl⁻+OH⁻−2e⁻→HOCl

The chlorine gas (Cl₂), hypochlorous acid (HOCl), and hypochlorite ion (OCl⁻) thereby produced can destroy bacteria.²²
²² Patermarakis G and Fountoukidis E, Disinfection of Water by Electrochemical Treatment, Wat. Res. Vol 24, No. 12, pp. 1491-1496, 1990.

Rupturing of Cell Membranes at the Anode

Many species of bacteria have a negatively charged surface. The positively charged electrode will attract these species. When the charge on the electrode exceeds a bacterium's electrostatic capacity, the bacterium's cell membrane will rupture.²³
²³ Yoshida K, Process for deactivating or destroying micro-organisms, U.S. Pat. No. 5,922,209, 1999.

The Action of Nascent and Molecular Hydrogen

Nascent hydrogen (H⁻) and molecular hydrogen (H₂) are vigorous electron donors. Both are produced at the cathode in the electrolytic cell. Both are available to perform reduction reactions.

Recent studies have shown that hydrogen can inhibit growth of biofilms and other bacterial cultures. For example, if methanogenic bacteria do not remove hydrogen, a product of their fermentation, then the hydrogen can impede or modify metabolic processes in some rumen bacteria.²⁴ The hydrogen sends to the biofilm's microbial community an environmental signal that induces certain metabolic pathways. We speculate that the electrolytic production of hydrogen and oxygen in the water will confound this signal interpretation, leading to either cell death from the hydrogen or inappropriate adaptation. Either event can prevent the microbes which are colonizing a biofilm from developing the symbiotic balance necessary for their survival^{25,26}
²⁴ Schlegel, Hans G., and Holger W. Jannasch. 4. Prokaryotes and their Habitats. The Prokaryotes. Ed. Mortimer P. Starr et al. Vol. 1. New York: Springer-Verlag

²⁵ Iannotti, E. L.; Kafkewit, D.; Wolin, M. J.; Bryant, M. P. 1973. “Glucose fermentation products of Ruminococcus albus grown in continuous culture with Vibrio succinogenes: Changes caused by interspecies transfer of H₂” Journal of Bacteriology, vol. 114, pp. 1231-1240.

²⁶ Wolin, M. J. and Miller, T. L. 1982. “Interspecies hydrogen transfer: 15 years later.” ASM-News, vol. 48, pp. 561-565

Evidence that Electrolyzed Water Can Remove Biofilms

Miox Corporation of Albuquerque, N. Mex. manufactures and sells water disinfection systems which add sodium chloride to water, then electrolyze the brine to create a “mixed oxidant” solution which consists of hypochlorous acid (HOCl) and other chlor-oxygen species. The free available chlorine concentration of the solution depends on the amperage, but it doesn't exceed 0.4%, which is below the 1% concentration threshold for hazardous classification. The systems store the mixed oxidant solution in an oxidant tank, then inject the mixed oxidant solution into the feed water stream at a rate appropriate for the application. The company's website documents the systems' ability to remove biofilms from pipes in water supply systems.²⁷
²⁷ http://www.miox.com/MIOX_process/biofilmmiox_process.html, accessed Mar. 21, 2003.

Removing Biofilms from Dental Unit Water Lines with Electrolyzed Water

A team of researchers at the University of Pretoria, South Africa has demonstrated that electrolyzed water can remove biofilms from dental unit water lines.²⁸ The researchers prepared “electro-chemically activated water” by placing feed water and brine into an electrolytic membrane cell. The electrolytic cell segregated the water near the anode (the anolyte) from the water near the cathode (the catholyte). The researchers asserted that the anolyte has an antimicrobial effect and the catholyte a detergent or cleaning effect. They fed the anolyte into seven dental operatories in the mornings. During the day, the dentists treated patients with the operatories. In the evening, the researchers flushed the dental units with the catholyte to counter the corrosive effects of the anolyte.
²⁸ Marais J T, Brözel VS., Electro-chemically activated water in dental unit water lines, British Dental Journal, Vol. 187, No. 3, Aug. 14, 1999.

Before the authors began introducing electrolyzed water into the seven dental units, water samples taken from the units' three-way syringes produced microbial counts of 3×10⁴ to 2×10⁵ CFU/ml. After one week, the electrolyzed water had reduced the counts below 1 CFU/ml. After 5 weeks, SEM studies indicated that biofilms were no longer present in the tubing. The authors credited the following biocidal agents in the electrolyzed water: ClO₂, HClO, Cl₂, ClO⁻, H₂O₂, HO₂⁻, H₂O₂, NaOH, O₂, O₃, ¹O₂, H, and OH.

From the standpoint of cost, simplicity, ease of use, and reliability, the experimental system employed in South Africa had these problems:
The need for a separate source of brine.
The need for tanks to keep the anolyte and the catholyte separate.
The need for a nocturnal flush with the catholyte.
The corrosion of operatory components from the separate use of the anolyte (an acid) and the catholyte (a base), both of which are corrosive when used independently.

### THE INVENTED METHOD AND APPARATUS

The electrolytic system of the invention continuously treats all the water coming into the dental unit. It does not segregate the anolyte from the catholyte. It does not require a separate source of salt or brine; instead, it generates hypochlorite and other active halide compounds from the salt naturally present in the municipal water supply (typically in concen-trations of 10 to 250 ppm). It does not require a periodic flush. The invention enable one to minimize cost, size, and maintenance requirements of the electrolytic system, while maximizing simplicity, reliability, and ease of use. The system will remove biofilms from infected tubing and then keep the tubes disinfected continuously with virtually no attention from the dental staff other than monthly maintenance.

The electrolytic cell of the invention will provide an ideal technological, economic, and practical solution to the problem of microbial contamination of dental unit water lines. It will enable dentists to provide water which meets drinking water standards. It will protect patients and dentists from potential adverse health effects of microbial contamination. It will protect dentists from adverse publicity and litigation. It may help the dental community to avert a public health crisis.

In this section, we explain precisely how and where we propose to achieve our technical objectives.

Design the Electrolytic Cells.

The most important specifications for the electrolytic cell (high voltage and low voltage) of the invention are:
Operating voltage: 2-36V DC
Operating amperage: 0.1-5 amps
Electrode spacing (low voltage, low amperage prototype): 0.02 inches plus or minus 0.0005 inches
Electrode spacing (high voltage, low amperage prototype): 0.08 inches plus or minus 0.0005 inches
Electrode size: 18-20 square inches of anode (cathode area not critical)
Water flow rate: 0.005-1 liter/minute
Current density: 0.01 to 0.3 Amps/sq inch

The invention could be used with municipal water which has total dissolved solids of about 125 ppm and conductivity of about 187.5 microSiemens per centimeter.

It is also desirable to vary the voltage without making substantial changes in the amperage. This can be accomplished by changing the overall resistance of the water which is in turn accomplished by varying the gap between the electrodes. Building two electrolytic cells with different electrode spacing is a way to accomplish the above objective.

To build the electrolytic cell of the invention, the following criteria must be met:
Materials of Construction
   For the anode, the preferred material is titanium coated with a transition metal oxide or suboxide such as iridium oxide, tantalum oxide, or ruthenium oxide. For the cathode, the preferred material is polished medical-grade stainless steel.
   The preferred material for the housing which holds the electrodes is low- and high-density polyethylene, Teflon™, and PVC.
   The preferred material from which to make the electrical termination for the electrodes is titanium and aluminum.
Geometry of the Electrolytic Cell
   The two preferred geometries are a parallel-plate configuration and a radial configuration (a “center-wire” cathode with an anode “pipe” surrounding it). The distance between the electrodes is an important design issue because it enables achieving the desired electrical operating conditions over the broadest range of water conditions without an expensive power supply/rectifier. It is also necessary to determine the dynamics of flow and the method of construction.
Waterflow Hydrodynamics
   The flow tube must be sized to provide appropriate residence time and boundary layer flow characteristics. End fittings for the flow tube must allow water to enter and exit the electrolytic cell. The system of the invention minimizes calcium scaling on the cathode and facilitates maintenance procedures associated with scale removal.
Electrical Controls
Suitable electrical controls monitor the performance of the electrolytic cell. If the voltage becomes too high or too low, the controls will either modify the settings on a variable-amperage power supply or shut the cell down.
   The controls will also shut down the system if the chlorine concentration in the output water exceeds a safety threshold, or if the electrolytic cell loses fluid.
   The control system also incorporates a programmable logic controller and a dedicated printed circuit board. It also meets the standards for UL certification.
Electrical Terminations
   Electrical connection to the electrodes must be done so that the electrical leads do not make direct contact with the water.

The electrolytic cell of the invention must be built to achieve relatively tight tolerances on the spacing of the electrodes (plus or minus 0.001 inches) and to weld the titanium properly. The electrolytic cells are assembled by suitably coupling the housings, the electrodes, the electrical connections, and the input and output fittings for the water lines. The electrolytic cell is then combined with the above-described electrical controls.

The electrolytic system of the invention is integrated into test apparatus such as that shown schematically in FIG. 1. The test apparatus is pressurized to 80 psi, a conventional operating pressure for a dental operatory. Tapwater flows through the electrolytic cell and into two test lines made from standard dental unit tubing.

To test the system, biofilms are grown in two dental unit water lines according to known principles, such as by sending tapwater through the test apparatus with power to the electrolytic cell shut off. To grow the biofilms in a controllable and reproducible way, the water is passed through an exhausted granular activated carbon column. This column will remove any residual free chlorine and any background natural organic carbon. It will also provide a continuous inoculum of indigenous bacteria for the system. Downstream from the column, organic carbon is added in sufficient quantity to create a concentration of 1 milligram per liter in the test water. The flow rate of the test water will be approximately 25 milliliters per minute.

The biofilms are allowed to grow for two weeks to be certain that they reach steady state (at which the newly grown material and the discharged material are approximately equal).

After the two-week biofilm growth period, the microbial content of the water flowing out of the two dental unit water lines is analyzed by standard plate counts and by a live/dead staining microscopy technique. These tests report the baseline concentration of bacteria in the output water (in colony forming units per milliliter) and the percentage of live bacteria.

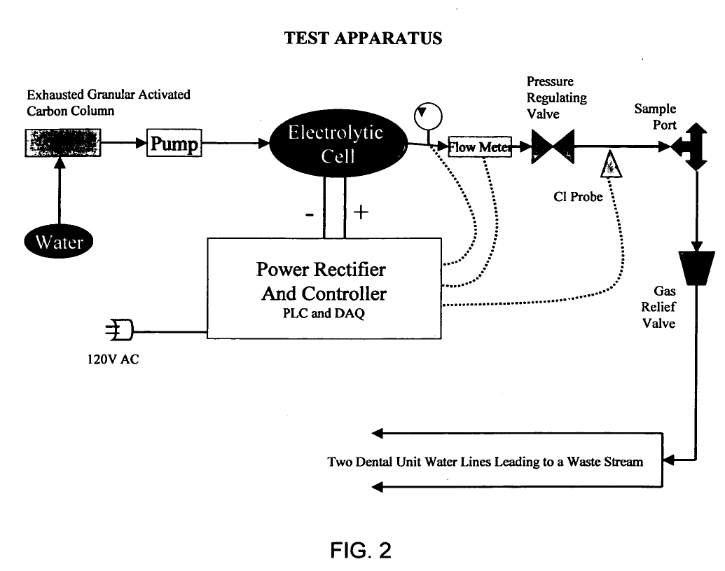

FIG. 2 shows certain test apparatus. Testing occurs for two nominally identical dental unit water lines with nominally identical biofilms. One of these lines is an experimental line; the other is the control. The experimental line is connected to the test apparatus and the control line is connected to the municipal water supply.

Before beginning the experiment, part of the control line is cut for analysis. Biofilm is scraped from a section of the inner wall of the dental tubing and measured as biomass per unit area.

The control line is then connected to the municipal water supply and the experimental line is connected to the test apparatus. An exhausted granular activated carbon column (as described above) I placed upstream from both the control line and the experimental line.

Power is then applied to the high-voltage (˜24 V, 1.8 A) electrolytic cell, and an operating voltage and amperage is established, to test the electrolytic system's ability to remove the biofilm from the experimental dental water unit line. Beakers collect all the water that emerges from this line, and the beakers are changed at 10-minute intervals. From each beaker water sample, there is analysis of the microbial content by standard plate counts and by a live/dead staining microscopy technique.

The test continues to collect and measure water samples from the experimental dental water unit line until the microbial content falls below the drinking water standard of 500 CFU/ml. The microbial content reaches this level within a few hours, and perhaps less than one hour. Once that level of microbial content occurs, the flow of water to the test apparatus is turned off, as is the power to the electrolytic system, and the flow of municipal water through the control water line.

During experimentation, samples from the control water line connected to the city water supply are collected every 30 minutes and analyzed for microbial content by the above methods.

Next, both water lines are cut open, and biofilm is scraped from the inner walls of both (if any biofilm remains in the experimental water line), and measured for biomass per unit area.

To analyze the data, one plots microbial content as a function of time for the water emerging from experimental line and the control line.

The experiment can be repeated, and during the second iteration, the second (low-voltage) electrolytic cell is used. The operating voltage and amperage on the electrolytic cell is selected based upon the results from the first experiment. At the conclusion of the second iteration, the experimental data is analyzed as described above.

In another experiment, one dental water line (the “experimental line”) is attached to the test apparatus. Untreated tapwater is sent through the electrolytic system and then through a dental water unit line. The operating voltage on the electrolytic cell is determined based upon the above-described experimental results.

For a control, a dental unit water line (the “control line”) is attached directly to a supply of municipal tapwater.

Next, flow rates of 25 milliliters per minute are established in both the experimental line and the control line. Microbial content of the output water from both lines is measured by live/dead staining microscopy once a day for two weeks.

The above experiment enables testing the hypotheses that:
the microbial content of the output water from the control line will increase rapidly as a function of time, indicating the growth of a biofilm within the line, and
the microbial content of the output water from experimental line will not increase, indicating the ability of the electrolyzed water to inhibit biofilm formation.

At the end of two weeks, both lines are cut open equivalent areas of the inner walls of the tubing are scraped and measured for biomass per unit area. This test allows for assessment of the ability of the apparatus of the invention to inhibit the growth of biofilms.

Output water from the apparatus of the invention is sent to an analytical laboratory with directions to test for the presence of the following metals in solution:
copper, which might come from water supply pipes or components within a dental operatory. It is also preferable to analyze the water for copper content upstream as well as downstream from the apparatus. Copper is a bactericide.
iron, which could consume part of the oxidative capacity of the electrolytic cell. Again it is preferable to test for iron both upstream and downstream from the electrolytic system.
titanium, to check for electrode degradation at the anode.
nickel, to check for electrode degradation at the cathode.

It is also desirable to measure the concentration of free active chlorine in the feed water and in the output water with a chlorine probe. Chlorine in the feed water will serve as a disinfectant. The biofilm growth system is intended to remove free chlorine from the city water supply to provide a reliable baseline for evaluation of the electrolytic system. The electrolytic system is expected to generate a drinkable level of residual free chlorine. Excessive free chlorine in the output water could constitute a health hazard.

It is also desirable to construct a safety circuit to measure the voltage and current. If either exceeds a safety threshold, it will shut down the system.

Electrolysis of water produces hydrogen, a flammable gas. The system of the invention will vent hydrogen to atmosphere through a gas relief valve (see FIG. 1). Hydrogen will not be explosive as long as it accounts for less than 4% of the atmosphere. It is also possible to run the output from the gas relief valve though a Raney nickel filter to convert the hydrogen into nickel metal hydride, a recyclable product.

In regions where the total dissolved solids of municipal water is low, electrolysis might generate only small quantities of hypochlorite or other active halide compounds. As a result, the system might not be able to disinfect the water successfully. In these cases, it might be necessary to feed a small quantity of brine into the municipal water in order to remove biofilms and inhibit growth of biofilms in the dental tubing. If so, we would engineer the system to operate in two modes, which we might call “clinical mode” and “maintenance mode.”
In clinical mode, the system would electrolyze only municipal tapwater. The output water from the dental unit in clinical mode would met all drinking water standards. The system would operate in clinical mode during business hours.
In maintenance mode, the system would electrolyze municipal water combined with a small quantity of brine. The output water from the dental unit in maintenance mode might contain levels of chlorine similar to those in a swimming pool and might be distasteful to a patient. The system would operate in maintenance mode for one or two hours out of every 24, at night when the dental operatory is not in use.

The system is constructed to switch back and forth between clinical mode and maintenance mode automatically without operator intervention. It is also designed with a robust feedback loop that tests the chlorine content of the output water and confirms that it is below a pre-set threshold value before allowing the system to enter clinical mode.

Dental units contain some combination of plastic tubing, brass- or nickel-plated components, and aluminum components. As long as the apparatus of the invention removes biofilms successfully and inhibits biofilms, the invention will not have any materials compatibility issues.

If a separate brine tank is used, then the electrolyzed water might oxidize the phthalate esters in the plastic tubing, causing the tubing to lose its elasticity and eventually to crack. In the worst case, the tubing should last at least a year without replacement.

The apparatus of the invention achieves either or both of the following:
reduce the microbial contamination of the water from its original value with the biofilm in place to below 500 colony forming units per milliliter, or
prevent the growth of a biofilm during the two-week inhibition test.

If either of the above are achieved, then the other can be achieved by adjusting the configuration of the electrolytic cell, by optimizing the voltage and the current density in the electrolytic cell, or by adding brine to the feed water.

The invention provides an ideal solution to the dental community's problem with contaminated water lines by:
deliver non-toxic water which meets all drinking water requirements,
detach biofilms from the inner walls of dental unit water lines,
prevent regrowth of biofilms on the inner walls of dental unit water lines,
protect the internal components of a dental offertory, and
operate in continuous mode.

If the system must also operate in batch cleaning mode, it should be designed to do so automatically, without operator intervention.

I claim:

1. Apparatus for removing and controlling microbial contamination in dental unit water, comprising:
a source of water;
an electrolytic subsystem located between the source and a dental unti that continuously treats all the water from the source before the water enters the dental unit; whereby the subsystem does not segregate the anolyte from the catholyte, does not require a separate source of salt or brine, and generates hypochlorite and other active halide compounds from salt naturally present in the water.

2. The apparatus of claim 1 wherein the electrolytic subsystem is formed as an electrolytic cell that can be located in-line between the source of water and the dental unit.
